(19) United States
(12) Patent Application Publication
(10) Pub. No.: US 2022/0098009 A1
(43) Pub. Date: Mar. 31, 2022

(54) LIFTING CONTROL DEVICE AND MOBILE CRANE

(71) Applicant: TADANO LTD., Kagawa (JP)

(72) Inventor: Yoshimasa MINAMI, Kagawa (JP)

(73) Assignee: TADANO LTD., Kagawa (JP)

(21) Appl. No.: 17/421,556

(22) PCT Filed: Feb. 14, 2020
(86) PCT No.: PCT/JP2020/005712

§ 371 Date: Jul. 8, 2021

(30) Foreign Application Priority Data
Feb. 14, 2019 (JP) 2019-024613

(51) Int. Cl. B66C 13/48; B66C 13/46

(52) U.S. Cl. CPC B66C 13/48; B66C 23/42; B66C 13/46

(57) ABSTRACT

Provided is a lifting control device that can quickly make lifting determinations while suppressing load vibration. The lifting control device D comprises: a boom 14 that is configured to be freely raised and lowered; a winch 13 to hoist and lower a suspended load via a wire rope 16; a load measurement means 22 to measure the load acting on the boom 14; and a controller 40 that controls the boom 14 and the winch 13, wherein when lifting a suspended load from the ground by winding up the winch 13, the controller 40 retains a maximum load value from a time series of load data as a variable, finds variations in the hoisting angle of the boom 14 on the basis of time variations in the maximum load value, and raises and lowers the boom 14 so as to compensate for the variation.

### TECHNICAL FIELD

The present invention relates to a lifting control device for suppressing a load swing when a suspended load is suspended from the ground.

### BACKGROUND ART

In the related art, there has been a problem of “load swing” that when a crane including a boom suspends a suspended load from the ground, that is, lifts a suspended load, the suspended load swings in the horizontal direction due to an increase in the working radius by a deflection generated in the boom (see FIG. 1).

For the purpose of preventing a load swing during lifting, a vertical lifting control device described in Patent Literature (hereinafter, referred to as “PTL”) 1, for example, is configured to detect an engine rotational speed by an engine rotational speed sensor and to correct a raising operation of a boom to a value corresponding to the engine rotational speed. Such a configuration is supposed to make it possible to perform an accurate lifting control in which changes in the engine rotational speed are taken into consideration.

### CITATION LIST

### Patent Literature

PTL 1
Japanese Patent Application Laid-Open No. H08-188379

### SUMMARY OF INVENTION

### Technical Problem

Lifting control devices in the related art including that of PTL 1 determine lifting based on a time series of load data. However, a time series of load data greatly vibrates under the influence of flexural vibration of a boom or the like. For this reason, the lifting control devices in the related art are to wait until load data is stabilized, which has been a factor due to which it takes time to determine lifting.

An object of the present invention is therefore to provide a lifting control device and a mobile crane that are capable of performing lifting at high speed while suppressing a load swing.

### Solution to Problem

In order to achieve the above-described object, a lifting control device of the present invention includes: a boom configured to be freely luffed up and down; a winch that hoists and lowers a suspended load via a wire rope; a load measurement section that measures a load acting on the boom; and a control section that controls the boom and the winch. When lifting of the suspended load is performed by hoisting the winch, the control section retains a maximum load value from a time series of load data as a variable, determines a variation in a luffing angle of the boom based on a temporal change in the maximum load value, and causes the boom to be luffed up and down so as to compensate for the variation.

### Advantageous Effects of Invention

As described above, the lifting control device of the present invention includes: a boom, a winch; a load measurement section; and a control section. When lifting of a suspended load is performed by hoisting the winch, the control section retains a maximum load value from a time series of load data as a variable, determines a variation in a luffing angle of the boom based on a temporal change in the maximum load value, and causes the boom to be luffed up and down so as to compensate for the variation. Given such a configuration, the lifting control device is capable of performing lifting at high speed while suppressing a load swing.

### BRIEF DESCRIPTION OF DRAWINGS

FIG. 1 is a diagram for describing a load swing of a suspended load;

FIG. 2 is a side view of a mobile crane;

FIG. 3 is a block diagram of a lifting control device:

FIG. 4 is a graph illustrating a load-luffing angle relationship;

FIG. 5 is a block diagram of the lifting control device in its entirety:

FIG. 6 is a block diagram of lifting control;

FIG. 7 is a flowchart for the lifting control:

FIGS. 8A and 8B are graphs for describing the concept of the lifting control based on a maximum load value; and

FIG. 9 is a block diagram for describing algorithm for updating the maximum load value.

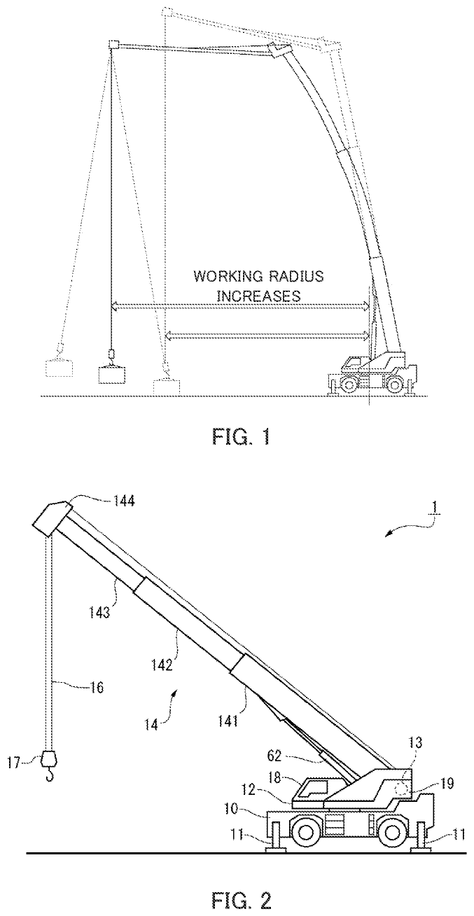

### DESCRIPTION OF EMBODIMENTS

Hereinafter, an embodiment according to the present invention will be described with reference to the accompanying drawings. It should be noted that the constituent elements described in the following embodiment are examples, and that the technical scope of the present invention is not intended to be limited only thereto.

### EMBODIMENT

As a mobile crane of the present embodiment, it is possible to mention, for example, a rough terrain crane, an all terrain crane, a truck crane, and the like. Hereinafter, as a work vehicle according to the present embodiment, a rough terrain crane will be described as an example, but a safety apparatus according to the present invention is also applicable to other mobile cranes.

(Configuration of Mobile Crane)

First, a configuration of the mobile crane will be described using a side view of FIG. 2. As illustrated in FIG. 2, rough terrain crane 1 of the present embodiment includes vehicle body 10, outrigger 11, swivel base 12, and boom 14. Vehicle body 10 serves as a main body portion of a vehicle having a traveling function. Outrigger 11 provided at each of the four corners of vehicle body 10. Swivel base 12 is attached to vehicle body 10 in a horizontally swivelable manner. Boom 14 is attached to the rear of swivel base 12.

Outrigger 11 is capable of slide-extending or slide-housing outward in the width direction from vehicle body 10 by extending or retracting a slide cylinder. Outrigger 11 is also capable of jack-extending or jack-housing in the vertical direction from vehicle body 10 by extending or retracting a jack cylinder.

Swivel base 12 includes a pinion gear to which the power of swivel motor 61 is transmitted. Swivel base 12 turns around a swivel shaft by meshing of the pinion gear with a circular gear provided in vehicle body 10. Swivel base 12 includes cockpit 18 disposed in the right front, and counter weight 19 disposed in the rear.

Further, winch 13 for hoisting and lowering wire 16 is disposed in the rear of swivel base 12. Winch 13 rotates in two directions of a hoisting direction (taking-up direction) and a lowering direction (feeding-out direction) by rotating winch motor 64 in the forward direction or the backward direction.

Boom 14 is formed of base-end boom 141, (one or a plurality of) intermediate boom(s) 142, and distal-end boom 143 in a telescopic manner, and is extendable and retractable by telescopic cylinder 63 disposed inside boom 14. A sheave is disposed at boom head 144 at the most distal end of distal-end boom 143. Wire rope 16 is wound around the sheave, and hook 17 is suspended from wire rope 16.

Base-end boom 141 includes a base portion that is turnably attached to a support shaft disposed on swivel base 12. Base-end boom 141 can be luffed up and down with the support shaft as the center of rotation. Further, luffing cylinder 62 is stretched between swivel base 12 and a lower surface of base-end boom 141. Boom 14 in its entirety can be luffed up and down by extending and retracting luffing cylinder 62.

(Configuration of Control System)

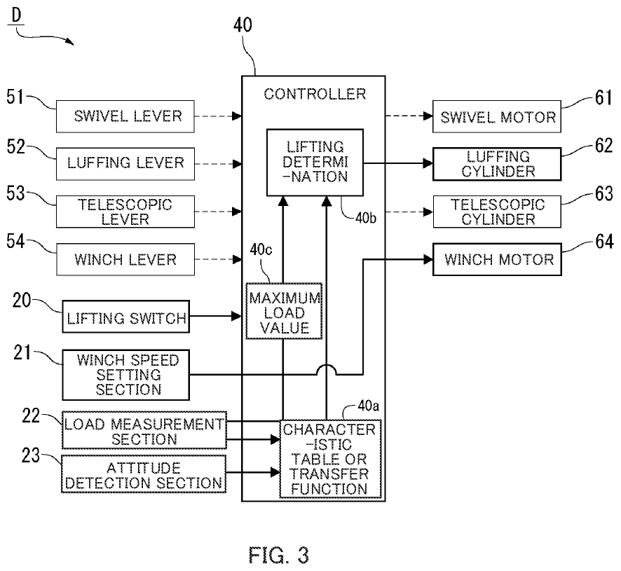

Next, a configuration of a control system of lifting control device D of the present embodiment will be described using a block diagram of FIG. 3. Lifting control device D is configured around controller 40 as a control section. Controller 40 is a general-purpose microcomputer including an input port, an output port, an arithmetic apparatus, and the like. Controller 40 receives an operation signal from operation levers 51 to 54 (swivel lever 51, luffing lever 52, telescopic lever 53, and winch lever 54), and controls actuators 61 to 64 (swivel motor 61, luffing cylinder 62, telescopic cylinder 63, and winch motor 64) via a control valve (not illustrated).

Further, lifting switch 20, winch speed setting section 21, load measurement section 22, and attitude detection section 23 are connected to controller 40 of the present embodiment. Lifting switch 20 is used to start and stop lifting control. Winch speed setting section 21 is used to set a speed of winch 13 in lifting control. Load measurement section 22 is used to measure a load acting on boom 14. Attitude detection section 23 is used to detect an attitude of boom 14.

Lifting switch 20 is an input apparatus for instructing the start or stop of lifting control. For example, lifting switch 20 can be configured to be added to a safety apparatus of rough terrain crane 1, and is preferably disposed in cockpit 18.

Winch speed setting section 21 is an input apparatus for setting the speed of winch 13 in lifting control. Examples of winch speed setting section 21 include those of a type in which an appropriate speed is selected from speeds set in advance and those of a type in which a speed is inputted with a ten key. Further, in the same manner as lifting switch 20, winch speed setting section 21 can be configured to be added to the safety apparatus of rough terrain crane 1, and is preferably disposed in cockpit 18. Adjusting the speed of winch 13 by winch speed setting section 21 described above makes it is possible to adjust the time required for lifting control.

Load measurement section 22 is a measurement apparatus that measures a load acting on boom 14. For example, load measurement section 22 can be pressure gauge 22 that measures pressure acting on luffing cylinder 62. A pressure signal measured by pressure gauge 22 is transmitted to controller 40.

Attitude detection section 23 is a measurement apparatus that detects the attitude of boom 14, and is formed of luffing angle meter 231 and luffing angular speed meter 232. Luffing angle meter 231 measures a luffing angle of boom 14. Luffing angular speed meter 232 measures a luffing angular speed. Specifically, a potentiometer can be used as luffing angle meter 231. Further, a stroke sensor attached to luffing cylinder 15 can be used as luffing angular speed meter 232. A luffing angle signal measured by luffing angle meter 231 and a luffing angular speed signal measured by luffing angular speed meter 232 are transmitted to controller 40.

Controller 40 is a control section that controls the operations of boom 14 and winch 13. When a suspended load is lifted by turning lifting switch 20 on to hoist winch 13, controller 40 predicts a variation in a luffing angle of boom 14 based on a temporal change in a load measured by load measurement section 22, and causes boom 14 to be luffed up and down so as to compensate for the predicted variation.

More specifically, controller 40 includes, as functional sections, selection function section 40a for a characteristic table or transfer function, lifting determination function section 40b, and maximum value updating function section 40c. Lifting determination function section 40b stops lifting control by determining whether lifting has been actually performed. Maximum value updating function section 40c retains a maximum load value from a time series of load data as a variable, and outputs the maximum load value to lifting determination function section 40b.

Selection function section 40a for a characteristic table or transfer function receives inputs of an initial pressure value from pressure gauge 22 as the load measurement section and an initial luffing angle value from luffing angle meter 23 as the attitude detection section, and determines a characteristic table or transfer function to be applied. Here, as the transfer function, a relationship using linear coefficient a can be applied as follows.

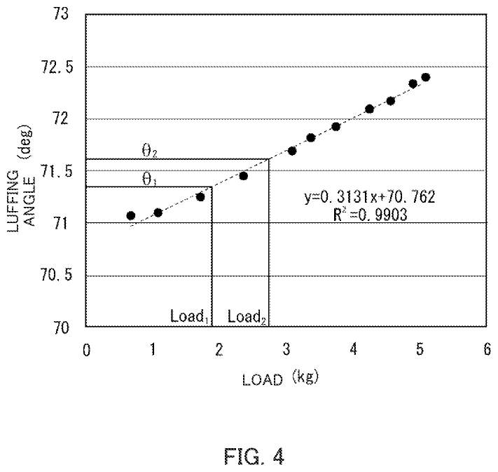

First, as illustrated in a load-luffing angle graph of FIG. 4, it is known that a load and a luffing angle (distal end-ground angle) have a linear relationship in a case where the position of a distal end of a boom is adjusted to be always directly above a suspended load such that a load swing does not occur. Assuming that Load₁ has changed to Load₂ between time t₁ and time t₂ during lifting,

[1]

APPROXIMATE EXPRESSION θ=a·Load+b

t₁θ₁=a·Load₁+b

t₂θ₂=a·Load₂+b (Expression 1).

When a difference equation is determined from a difference between two expressions,

[2]

θ₂−θ₁=a(Load₂−Load₁)

Δθ=a·ΔLoad (Expression 2).

In order to control the luffing angle, it is necessary to give the luffing angular speed.

$$\begin{matrix}[ 3 ] & \\ {V}_{Drc} = \frac{Δθ}{( {t}_{2} - {t}_{1} )} = a \cdot \frac{ΔLoad}{Δ t} = a \cdot {\dot{L}}_{Load} & ( Expression 3 )\end{matrix}$$

where a represents a constant (linear coefficient).

That is, in luffing angle control, a temporal change in a load (differentiation) is inputted.

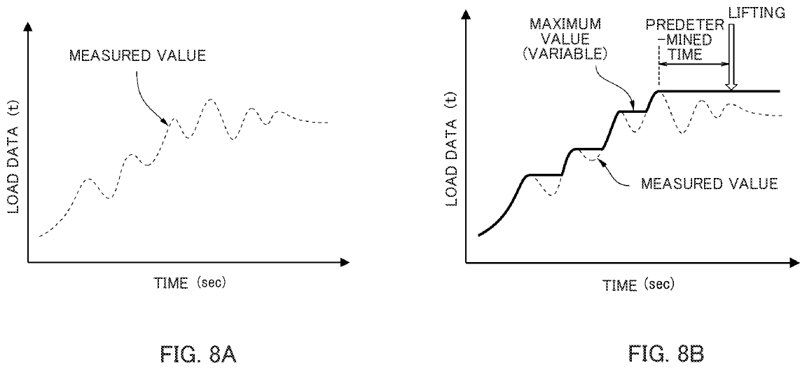

Lifting determination function section 40b receives a maximum load value at that time from maximum value updating function section 40c, and determines based on a temporal change in the maximum load value whether lifting has been performed or not. The method of lifting determination will be described later using FIGS. 8A and 8B.

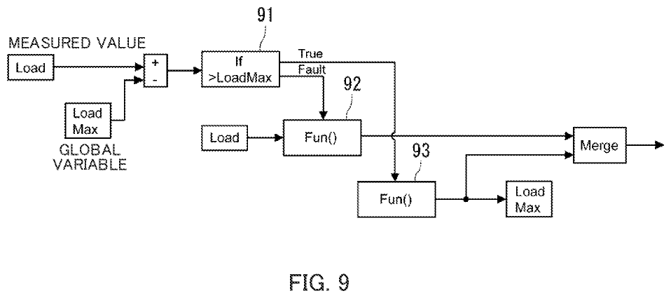

Maximum value updating function section 40c calculates a load value from a pressure signal from pressure gauge 22 as the load measurement section, and retains a maximum load value, which is the maximum value of a load at that time, from time-series data of the calculated load value as a variable. Further, maximum value updating function section 40c updates the maximum load value by comparing the maximum load value with measured data at that time, and then passes the updated maximum load value to lifting determination function section 40b. Algorithm for updating the maximum load value will be described later using FIG. 9.

(Overall Block Diagram)

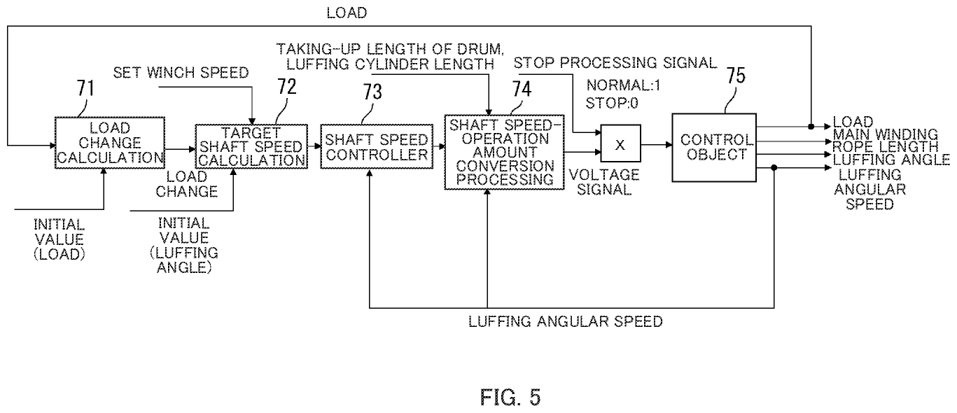

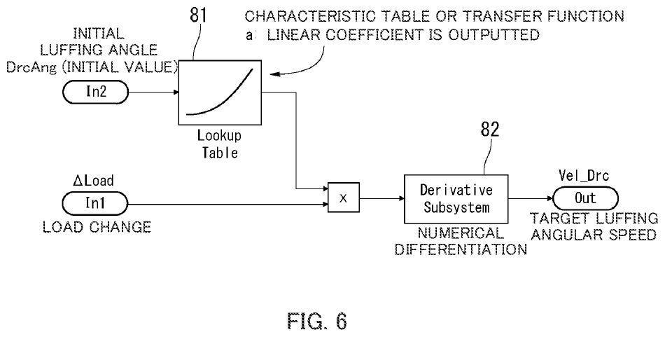

Next, input-output relationships between elements in their entirety including lifting control of the present embodiment will be described in detail using a block diagram of FIG. 5. First, in load change calculation section 71, based on time-series data of a maximum load value from loads measured by load measurement section 22, a temporal change in the maximum load value is calculated. The calculated temporal change in the maximum load value is inputted into target shaft speed calculation section 72. The input-output relationship in target shaft speed calculation section 72 will be described later using FIG. 6.

In target shaft speed calculation section 72, a target shaft speed is calculated based on an initial luffing angle value, a set winch speed, and an inputted temporal change in a maximum load value. The target shaft speed herein is a target luffing angular speed (and, although not essential, a target winch speed). The calculated target shaft speed is inputted into shaft speed controller 73. The control in the first half portion to this point represents processing related to the lifting control of the present embodiment.

Thereafter, the processing passes through shaft speed controller 73 and shaft speed-operation amount conversion processing section 74, and then an operation amount is inputted into control object 75. This control in the second half portion represents processing related to normal control, and feedback control is performed based on a measured luffing angular speed.

(Block Diagram of Lifting Control)

Next, especially the input-output relationship of elements in target shaft speed calculation section 72 in the lifting control will be described using a block diagram of FIG. 6. First, an initial luffing angle value is inputted into selection function section 81 (40a) for a characteristic table or transfer function. In selection function section 81, constant (linear coefficient) a that is most appropriate is selected using a characteristic table (Lookup Table) or transfer function.

Then, in numerical differentiation section 82, numerical differentiation of a load change (differentiation with respect to time) is performed and a result of the numerical differentiation is multiplied by constant a, thereby calculating a target luffing angular speed. That is, the target luffing angular speed is calculated by execution of the calculation of expression 3 described above. Thus, in the control of the target luffing angular speed, feed forward control is performed using a characteristic table (or transfer function).

(Flowchart)

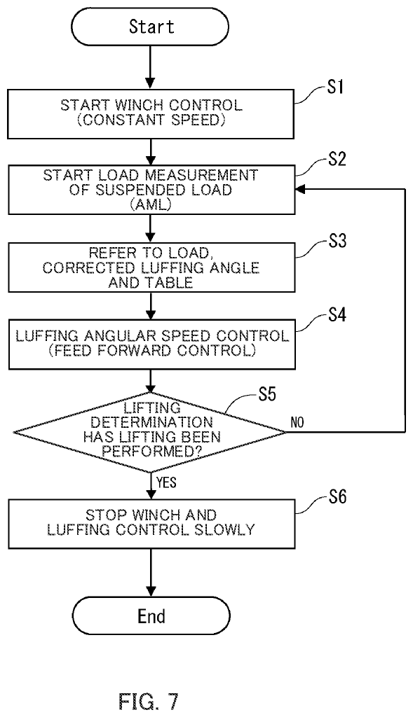

Next, an overall flow of the lifting control of the present embodiment will be described using a flowchart of FIG. 7.

First, an operator presses lifting switch 20 to start lifting control (START). At this time, a target speed of winch 13 is set via winch speed setting section 21 in advance before or after the start of the lifting control. Then, controller 40 starts winch control at the target speed (step S1).

Next, winch 13 is hoisted and load measurement of a suspended load is started by load measurement section 22 at the same time, and a load value is inputted into controller 40 (step S2). Then, selection function section 40a receives inputs of an initial load value and an initial luffing angle value from luffing angle meter 23 as the attitude detection section, and determines a characteristic table or transfer function to be applied (step S3).

Next, controller 40 calculates a luffing angular speed based on the characteristic table or transfer function to be applied and a temporal change in a maximum load value (step S4). That is, luffing angular speed control is performed by feed forward control.

Then, it is determined based on the temporal change in the maximum load value whether lifting has been performed or not (step S5). Note that, the determination method will be described later. In a case where lifting has not been performed as a result of the determination (NO in step S5), the flow returns to step S2, and the feed forward control based on the load is repeated (steps S2 to S5).

In a case where lifting has been performed as a result of the determination (YES in step S5), the lifting control is slowly stopped (step S6). That is, rotation driving of winch 13 by the winch motor is stopped while decreasing the speed, and luffing driving by luffing cylinder 62 is stopped while decreasing the speed.

(Update Algorithm for Maximum Load Value, and Lifting Determination)

Next, update algorithm for a maximum load value and a lifting determination method of the present embodiment will be described in detail using FIGS. 8A, 8B, and 9.

As described above, controller 40 includes, as its function section, maximum value updating function section 40c for retaining a maximum load value from a time series of load data as a variable when lifting of a suspended load is performed by hoisting winch 13.

That is, as illustrated in FIGS. 8A and 8B, maximum value updating function section 40c updates a maximum load value, which are the maximum value of successive loads, from load time-series data (measured value) that vibrates under the influence of bending vibration due to a deflection of boom 14 (see FIG. 8A), and retains the maximum load value as a variable (see FIG. 8B). In that case, as illustrated in FIG. 8B, the maximum load value (the solid line in the drawing) becomes a horizontal line or a line rising to the right with time in the graph. That is, portions of the line, which fall to the right, will be removed.

Specifically, as illustrated in a block diagram of FIG. 9, algorithm for updating this maximum load value prepares a global variable (array) termed as “maximum load value” (Load Max), compares a measured value with the “maximum load value”, which is the global variable, for each time step (comparison section 91), and causes a larger value to be stored in the “maximum load value” of the global variable (elements 92 and 93). This processing is repeatedly executed during lifting processing.

Then, controller 40 monitors changes with time in the “maximum load value”, and determines that lifting has been performed, based on continuation of a state in which the maximum load value does not change over a predetermined time. That is, as illustrated in FIG. 8B, since the amplitude of load data is attenuated with time after lifting is performed, the maximum load value is not updated and a constant value continues. Accordingly, capturing this steady state makes it possible to determine that lifting has been performed.

Then, in the present embodiment, as described using FIGS. 6 and 7, a relationship between a temporal change in a maximum load value and a control amount (luffing angular speed) becomes theoretically linear by performing feed forward control so that compatibility can be said to be particularly good. That is, since the maximum load value that is successively updated changes only in the positive direction (increase direction), the linearity of load data becomes clearer by removal of vibration components so that it becomes easier to grasp a load change and to control a luffing angular speed.

(Effects)

Next, effects attainable by lifting control device D and rough terrain crane 1 as the mobile crane in the present embodiment will be enumerated and described.

(1) Further, lifting control device D of the present embodiment includes boom 14, winch 13, load measurement section 22, and controller 40 as a control section that controls boom 14 and winch 13. When lifting of a suspended load is performed by hoisting winch 13, controller 40 retains a maximum load value from a time series of load data as a variable, determines a variation in a luffing angle of boom 14 based on a temporal change in the maximum load value, and causes boom 14 to be luffed up and down so as to compensate for the variation. Given such a configuration, lifting control device D is capable of lifting a suspended load at high speed while suppressing a load swing.

That is, lifting control device D is capable of removing vibrating components in data by paying attention to temporal changes in successive maximum load values. When there is a deflection vibration of boom 14, it is necessary to wait to determine whether data converges or not beyond the natural period of the deflection vibration. Lifting control device D of the present embodiment, on the other hand, performs lifting at high speed. Accordingly, lifting control device D of the present embodiment solves the aforementioned problem by performing lifting within the natural period of a deflection vibration or before a deflection vibration occurs.

Further, lifting control device D pays attention to the fact that a relationship between a temporal change in a maximum load value and a luffing angle is a linear relationship, and performs feed forward control based only on the temporal change in the maximum load value, thereby being capable of lifting a suspended load at a very high speed without performing complicated feedback control as in the related art. In particular, in the present embodiment, a relationship between a temporal change in a maximum load value and a control amount (luffing angular speed) becomes theoretically linear by performing feed forward control so that compatibility can be said to be particularly good.

(2) In addition, lifting control device D preferably further includes attitude detection section 23 that measures an attitude of boom 14, and controller 40 preferably selects a corresponding characteristic table or transfer function based on an initial value of the measured attitude of boom 14 and an initial value of the measured load, and determines the variation in the luffing angle of boom 14 from the temporal change in the maximum load value by using the characteristic table or transfer function.

With such a configuration, it is possible to perform lifting at high speed without a load swing by hoisting winch 13 at a constant speed at the time of start of lifting control and calculating a luffing angle control amount from a characteristic table (or transfer function) in accordance with a temporal change in a maximum load value to perform feed forward control. In addition, parameters to be adjusted become fewer so that adjustment at the time of shipment can be quickly and easily performed.

(3) Further, when the lifting of the suspended load is performed by hoisting winch 13, controller 40 preferably causes winch 13 to be hoisted at a constant speed. With such a configuration, lifting control device D is capable of facilitating lifting determination by suppressing an influence of disturbance such as an inertial force to stabilize a response (measured load value).

(4) Further, when the lifting of the suspended load is performed by hoisting winch 13, controller 40 determines that the lifting has been performed, based on continuation of a state in which the maximum load value does not change over a predetermined time. With such a configuration, lifting control device D is capable of easily and at high speed determining whether lifting has been performed or not, by utilizing a maximum load value used in feed forward control.

(5) Further, rough terrain crane 1 that is a mobile crane of the present embodiment includes lifting control device D that is any of those described above. Accordingly, rough terrain crane 1 is capable of lifting a suspended load at high speed while suppressing a load swing.

Although the embodiment of the present invention has been described in detail with reference to the drawings thus far, specific configurations are not limited to those in this embodiment, and design changes to the extent that the changes do not deviate from the gist of the present invention are included in the present invention.

For example, although description has not specially been given in the embodiment, lifting control device D of the present invention is applicable even in a case where lifting is performed using a main winch as winch 13 and even in a case where lifting is performed using a sub winch.

### REFERENCE SIGNS LIST

D: Lifting control device;
a: Linear coefficient;
1: Rough terrain crane;
10: Vehicle body;
12: Swivel base:
13: Winch;
14: Boom;
16: Wire;
17: Hook;
20: Lifting switch:
21: Winch speed setting section;
22: Pressure gauge (load measurement section):
23: Luffing angle meter (attitude detection section);
40: Controller;
40a: Selection function section;
40b: Lifting determination function section;
40c: Maximum value updating function section;
51: Swivel lever;
52: Luffing lever;
53: Telescopic lever;
54: Winch lever;
61: Swivel motor;
62: Luffing cylinder:
63: Telescopic cylinder;
64: Winch motor

1. A lifting control device, comprising:
a boom configured to be freely luffed up and down;
a winch that hoists and lowers a suspended load via a wire rope;
a load measurement section that measures a load acting on the boom; and
a control section that controls the boom and the winch, wherein
when lifting of the suspended load is performed by hoisting the winch, the control section retains a maximum load value from a time series of load data as a variable, determines a variation in a luffing angle of the boom based on a temporal change in the maximum load value, and causes the boom to be luffed up and down so as to compensate for the variation.

2. The lifting control device according to claim 1, further comprising an attitude detection section that measures an attitude of the boom, wherein
the control section selects a corresponding characteristic table or transfer function based on an initial value of the measured attitude of the boom and an initial value of the measured load, and determines the variation in the luffing angle of the boom from the temporal change in the maximum load value by using the characteristic table or transfer function.

3. The lifting control device according to claim 1, wherein
when the lifting of the suspended load is performed by hoisting the winch, the control section causes the winch to be hoisted at a constant speed.

4. The lifting control device according to claim 1, wherein
when the lifting of the suspended load is performed by hoisting the winch, the control section determines that the lifting has been performed, based on continuation of a state in which the maximum load value does not change over a predetermined time.

5. A mobile crane, comprising the lifting control device according to claim 1.
